(19) United States
(12) Patent Application Publication
(10) Pub. No.: US 2023/0072733 A1
(43) Pub. Date: Mar. 9, 2023

(54) BATTERY MODULE AND BATTERY PACK INCLUDING BATTERY MODULES

(71) Applicant: SUBARU CORPORATION, Tokyo (JP)

(72) Inventors: Yutaka YOKOYAMA, Tokyo (JP); Shinichi KIMURA, Tokyo (JP)

(21) Appl. No.: 17/870,521

(22) Filed: Jul. 21, 2022

(30) Foreign Application Priority Data
Sep. 6, 2021 (JP) 2021-144867

(51) Int. Cl. H01M 10/6562; H01M 10/6556; H01M 50/244; H01M 50/249; H01M 50/264; H01M 50/271; H01M 10/613; H01M 10/625

(52) U.S. Cl. CPC H01M 10/6562; H01M 10/6556; H01M 50/244; H01M 50/249; H01M 50/264; H01M 50/271; H01M 10/613; H01M 10/625; H01M 2220/20

(57) ABSTRACT

A battery module includes a battery stack, a bottom plate, end plates, and side plates. The battery stack includes battery cells that are arranged in a first direction. The bottom plate covers a bottom surface of the battery stack. The end plates respectively cover first ends of the battery stack. The first ends are disposed in the first direction. The side plates respectively cover second ends of the battery stack. The second ends are disposed in a second direction orthogonal to the first direction. Each of the side plates includes a first coupling protrusion protruding upward of the battery stack. The bottom plate includes a second coupling protrusion protruding downward of the battery stack.

### CROSS-REFERENCE TO RELATED APPLICATIONS

The present application claims priority from Japanese Patent Application No. 2021-144867 filed on Sep. 6, 2021, the entire contents of which are hereby incorporated by reference.

### BACKGROUND

The disclosure relates to battery modules that can be arranged in accordance with the space of a placement area, etc., and to a battery pack including the battery modules.

In one example, a structure disclosed in Japanese Unexamined Patent Application Publication (JP-A) No. 2016-46211 is a typical structure of a battery pack that contains a plurality of battery modules.

The battery pack is used in electric vehicles that require a large driving force, such as electric vehicles and hybrid vehicles. The battery pack includes a plurality of battery modules and a battery case for containing the plurality of the battery modules at mutual intervals. The battery case has a tray for fixing each battery module and a cover for covering an upper part of the tray.

In another example, a structure disclosed in Japanese Unexamined Patent Application Publication (JP-A) No. 2014-99257 is also a typical structure of a battery pack for containing battery modules.

The battery pack includes battery modules that are stacked in the height direction in order to improve an efficiency of mounting the battery modules on a vehicle. The battery pack has a base frame, a middle frame, and a cover member that are assembled to form two spaces for containing battery modules in the upper-lower direction. The battery modules are contained in these mounting spaces and are fixed with stud bolts provided in the frames.

### SUMMARY

An aspect of the disclosure provides a battery module including a battery stack, a bottom plate, end plates, and side plates. The battery stack includes a battery cells that are arranged in a first direction. The bottom plate covers a bottom surface of the battery stack. The end plates respectively cover first ends of the battery stack. The first ends are disposed in the first direction. The side plates respectively cover second ends of the battery stack. The second ends are disposed in a second direction orthogonal to the first direction. Each of the side plates includes a first coupling protrusion protruding upward of the battery stack. The bottom plate includes a second coupling protrusion protruding downward of the battery stack.

An aspect of the disclosure provides a battery pack including battery modules and a cover plate. Each of the battery modules is the above-described battery module comprising the above-described battery stack, the above-described first coupling protrusion and the above-described second protrusion. The battery modules comprises battery stacks each of which is the battery stack, first protrusions each of which is the first protrusion, and second protrusions each of which is the second protrusion. The cover plate covers upper surfaces of the battery stacks. The cover plate is fixed to the first coupling protrusions. The battery modules are configured such that (i) the battery modules are fixed in a stacked manner by coupling the first coupling protrusions and the second coupling protrusions to each other in a height direction of the battery stacks, and (ii) the battery modules are fixed in parallel by coupling the cover plate and the first coupling protrusions.

### BRIEF DESCRIPTION OF THE DRAWINGS

The accompanying drawings are included to provide a further understanding of the disclosure and are incorporated in and constitute a part of this specification. The drawings illustrate an example embodiment and, together with the specification, serve to describe the principles of the disclosure.

FIG. 1 is a schematic diagram of a vehicle equipped with a battery pack including one or more battery modules of an embodiment of the disclosure.

FIG. 2 is a perspective view of the battery module of the embodiment of the disclosure.

FIG. 3 is an exploded perspective view of the battery module of the embodiment of the disclosure.

FIG. 4 is a sectional view of the battery module of the embodiment of the disclosure.

FIG. 5A is a perspective view of the battery pack including the battery modules of the embodiment of the disclosure.

FIG. 5B is a perspective view of the battery pack including the battery modules of the embodiment of the disclosure.

FIG. 5C is a perspective view of the battery pack including the battery modules of the embodiment of the disclosure.

FIG. 5D is a perspective view of the battery pack including the battery modules of the embodiment of the disclosure.

FIG. 6A is a perspective view of the battery module of the embodiment of the disclosure.

FIG. 6B is a sectional view of the battery module of the embodiment of the disclosure.

FIG. 6C is a sectional view of the battery module of the embodiment of the disclosure.

### DETAILED DESCRIPTION

The battery pack that is disclosed in JP-A No. 2016-46211 has a battery case for containing a plurality of battery modules. The tray of the battery case is made of sheet metal and has an upper surface on which the battery modules are directly placed. The tray is provided with fixing parts for fixing the battery modules, and the battery modules are fixed to the fixing parts via brackets by bolts and nuts.

Due to this structure, the battery pack uses a battery case for containing the battery modules, resulting in increases in production cost and weight of the battery pack. Moreover, since the space for housing a battery pack and the number of battery modules to be used differ depending on the vehicle type, the battery case is prepared for each vehicle type, which causes difficulty in reducing production cost of the battery pack.

The battery pack that is disclosed in JP-A No. 2014-99257 has a frame for fixing battery modules in a stacked manner. Due to this structure, a frame that is a body separated from the battery module is used, whereby it is difficult to reduce production cost. In addition, the frame having such a structure is unable to be used in fixing the battery modules in parallel to each other in the battery pack.

It is desirable to provide battery modules that can be arranged in accordance with the space of a placement area, etc., and to provide a battery pack including the battery modules.

Hereinafter, a battery module 13 and a battery pack 10 including the battery module 13 according to an embodiment of the disclosure will be described in detail based on drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. The front-rear direction illustrated on the paper represents a front-rear direction of a vehicle 11, the right-left direction illustrated on the paper represents a vehicle width direction of the vehicle 11, and the up-down direction illustrated on the paper represents a height direction of the vehicle 11.

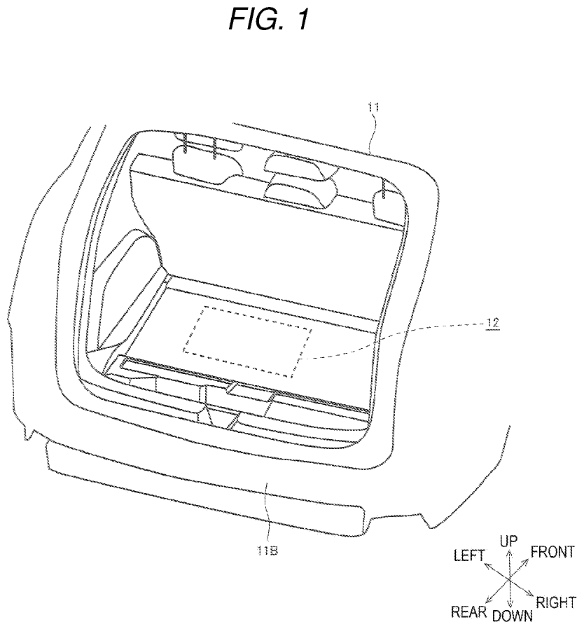

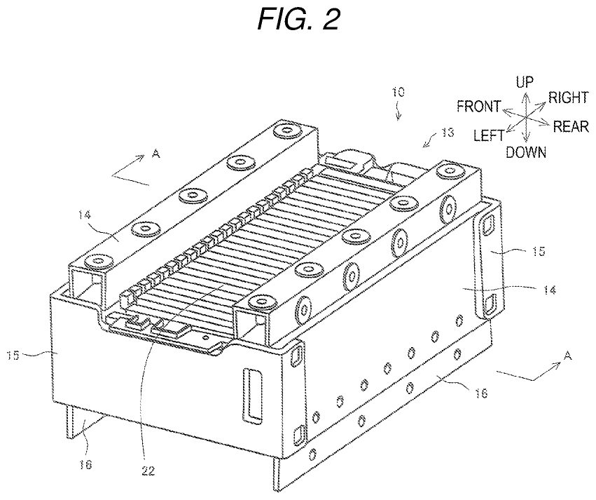

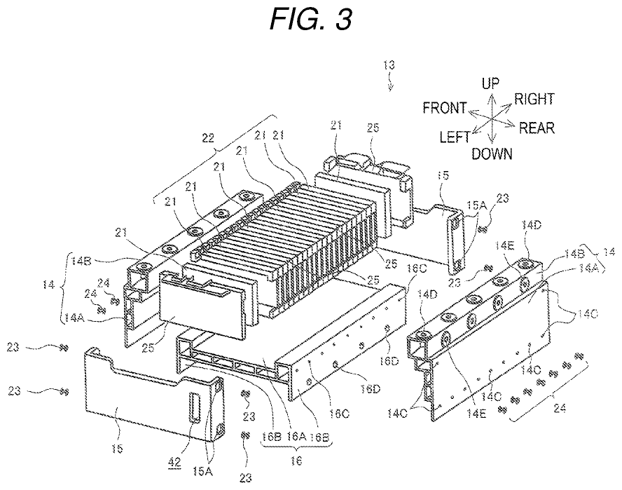

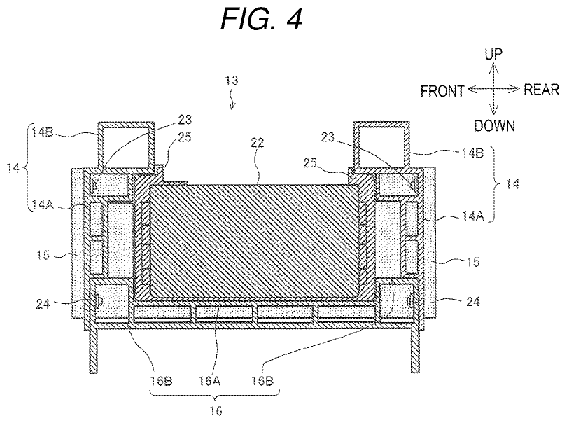

FIG. 1 is a schematic diagram of the vehicle 11 equipped with the battery pack 10 (refer to FIG. 2) of this embodiment. FIG. 2 is a perspective view of the battery module 13 of the battery pack 10 of this embodiment. FIG. 3 is an exploded perspective view of the battery module 13 of the battery pack 10 of this embodiment. FIG. 4 is a sectional view of the battery module 13 of the battery pack 10 of this embodiment and shows a cross section, in a direction of an A-A line, of the battery module 13 in FIG. 2.

As illustrated in FIG. 1, the vehicle 11, which is an automobile, a train, or the like, is mounted with the battery pack 10 (refer to FIG. 2) for supplying power to a motor and various electric components. As to an automobile for the vehicle 11, automobiles such as electrical vehicles (EVs), hybrid electrical vehicles (HEVs), and plug-in hybrid electrical vehicles (PHEVs) have been widely spread in recent years.

The battery pack 10 is disposed in, for example, a housing space 12 under a rear floor on a rear side of the vehicle 11, in such a manner that a longer direction of the battery pack 10 coincides with the right-left direction of the vehicle 11. The placement position of the battery pack 10 is not limited to the housing space 12 under the rear floor and may be a housing space such as under a front floor on which a driver's seat and a passenger seat of the vehicle 11 are placed. In addition, depending on the housing space 12, for example, the longer direction of the battery pack 10 may be made coincide with the front-rear direction of the vehicle 11.

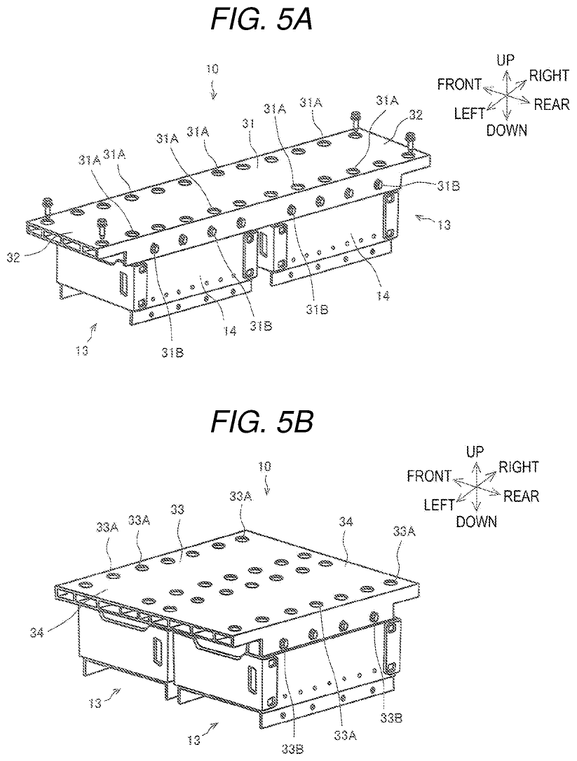

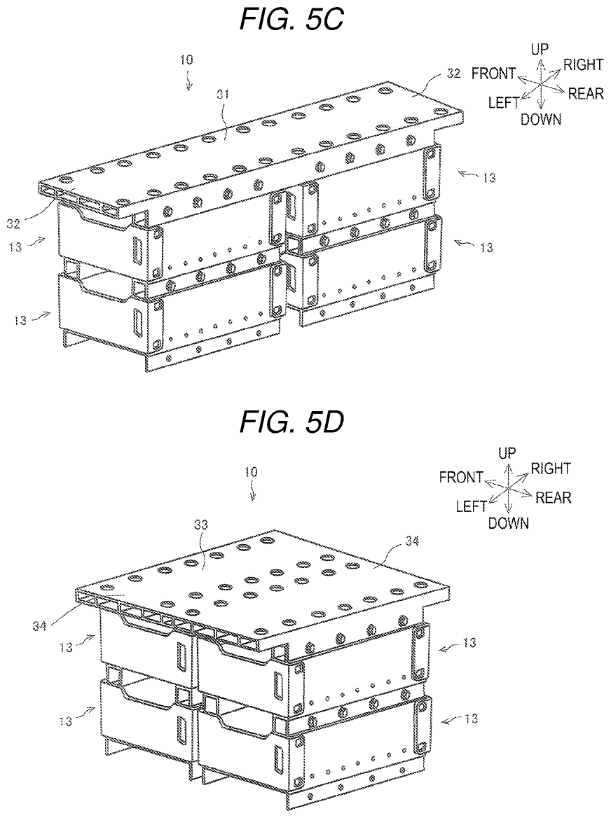

As illustrated in FIG. 2, the battery pack 10 includes at least one battery module 13. A plurality of battery modules 13 may be used in the battery pack 10 in a state of being coupled to one another in series and/or parallel in accordance with a power supply amount and so on in the vehicle 11. Note that the battery pack 10 is mounted to the vehicle 11 by using a cover plate 31 or 33, which are illustrated in FIGS. 5A to 5D.

The battery module 13 mainly includes a battery stack 22, a pair of side plates 14, a pair of end plates 15, and a bottom plate 16. The battery stack 22 includes a plurality of battery cells 21 (refer to FIG. 3). The side plates 14 cover both side surfaces, in the shorter direction (front-rear direction illustrated on the paper), of the battery stack 22. The end plates 15 cover both side surfaces, in the longer direction (right-left direction illustrated on the paper), of the battery stack 22. The bottom plate 16 covers the bottom of the battery stack 22.

Although not illustrated, a bus bar being coupled to the battery stack 22, an insulating cover covering the bus bar, and so on, are disposed on the upper surface of the battery module 13. The battery module 13 is electrically coupled to a battery control unit (BCU), which is an electronic equipment, and a junction box.

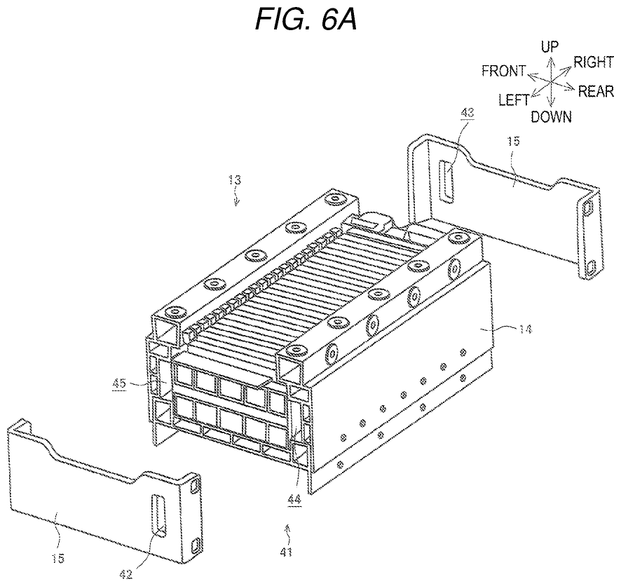

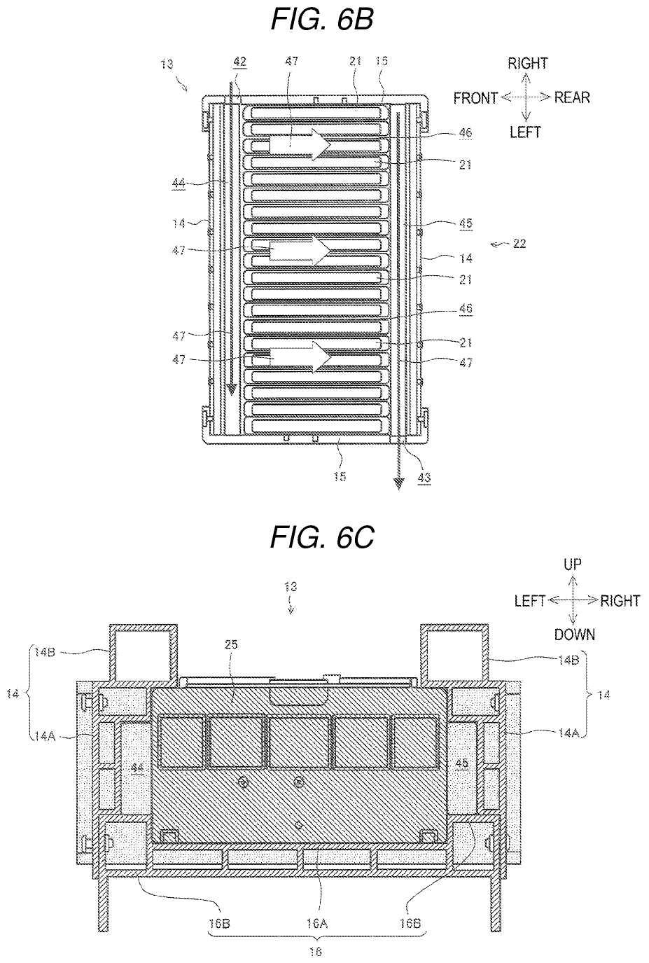

As illustrated in FIG. 3, the battery stack 22 is placed on the upper surface of the bottom plate 16, and the plurality of the battery cells 21 are coupled to one another in series via a bus bar (not illustrated). The battery cell 21 is, for example, a secondary battery, such as a nickel hydrogen battery or a lithium ion battery. The battery cells 21 each have, for example, a rectangular plate shape, and are arranged with a cooling gap 46 (refer to FIG. 6B) on each of forward and rear sides, at equal intervals along the longer direction (right-left direction illustrated on the paper) of the battery stack 22. In one embodiment, the array direction of the battery cells 21 may correspond to a “first direction”, and a direction orthogonal to the array direction of the battery cells 21 may correspond to a “second direction”.

The side plate 14 is formed of an aluminum extruded material, for example. The side plate 14 is arranged along the longer direction of the battery stack 22. The side plate 14 has a plate-shaped body 14A and a first coupling protrusion 14B. The plate-shaped body 14A covers the side of the battery stack 22. The first coupling protrusion 14B is disposed on top of the plate-shaped body 14A.

The first coupling protrusion 14B is used to fix a plurality of the battery modules 13 in a stacked or parallel manner in electrically coupling the battery modules 13 in the battery pack 10. The plate-shaped body 14A has a plurality of coupling holes 14C for coupling to the end plate 15 and the bottom plate 16 via, for example, rivets 23 and 24. Meanwhile, the first coupling protrusion 14B has two types of coupling holes 14D and 14E.

The plurality of the coupling holes 14D are provided in the upper surface of the first coupling protrusion 14B. The first coupling protrusion 14B is coupled to the cover plate 31 or 33 (refer to FIG. 5A or 5B) via the coupling holes 14D by using bolts and nuts. Meanwhile, the plurality of the coupling holes 14E are provided on the side surface of the first coupling protrusion 14B. In fixing the battery module 13 to another battery module 13 in a stacked manner, the first coupling protrusion 14B is coupled to the bottom plate 16 of the other battery module 13 via the coupling holes 14E by using bolts and nuts.

The bottom plate 16 is formed of an aluminum extruded material, for example. The bottom plate 16 is arranged along the longer direction (right-left direction illustrated on the paper) of the battery stack 22. The bottom plate 16 has a receiving body 16A, on which the battery stack 22 is placed, and second coupling protrusions 16B that are respectively disposed at ends of the receiving body 16A.

The second coupling protrusion 16B is used to fix a plurality of the battery modules 13 in a stacked manner in electrically coupling the battery modules 13 in the battery pack 10. The second coupling protrusion 16B has two types of coupling holes 16C and 16D on its side.

The plurality of the coupling holes 16C are provided on an upper side of the second coupling protrusion 16B. The second coupling protrusion 16B is coupled to the side plate 14 of the same battery module 13 as that thereof via the coupling holes 16C, for example, by rivets 24. Meanwhile, the plurality of the coupling holes 16D are provided on a lower side of the second coupling protrusion 16B. In fixing the battery module 13 to another battery module 13 in a stacked manner, the second coupling protrusion 16B is coupled to the side plate 14 of the other battery module 13 via the coupling holes 16D, for example, by using bolts and nuts.

The end plate 15 is formed, for example, by bending a steel plate. The end plate 15 covers each of a front end surface and a rear end surface, in the longer direction, of the battery stack 22. Although details will be described later, the end plate 15 on the front end side (left side illustrated on the paper) has an air inlet 42, whereas the end plate 15 on the rear end side (right side illustrated on the paper) has an air outlet 43 (refer to FIG. 6A). The air inlet 42 and the air outlet 43 constitute a cooling mechanism 41 (refer to FIG. 6A) of the battery module 13.

A separator 25 is interposed between the end plate 15 and the battery stack 22 and is also interposed between the battery cells 21. The separator 25 is, for example, an insulating member formed by using a resin mold. The separators 25 fix the plurality of the battery cells 21 thereinside and support the battery stack 22. The separator 25 is fixed to the bottom plate 16, whereby the battery stack 22 is also fixed to the bottom plate 16. Although details will be described later, the separator 25 is fixed in the state of being held between the first coupling protrusion 14B of the side plate 14 and the receiving body 16A.

As illustrated in FIG. 4, the first coupling protrusion 14B of the side plate 14 is provided as a skeletal frame of a hollow structure having an approximately square shape in a sectional view. The first coupling protrusion 14B is disposed on an upper side in the vicinity of each end, in the shorter direction (front-rear direction illustrated on the paper), of the battery stack 22. The first coupling protrusion 14B extends in the longer direction (right-left direction illustrated on the paper) of the battery stack 22.

Meanwhile, the second coupling protrusion 16B of the bottom plate 16 is provided as a skeletal frame of a hollow structure of an approximately square shape in a sectional shape. The second coupling protrusion 16B is disposed on a lower side in the vicinity of each end, in the shorter direction (front-rear direction illustrated on the paper), of the battery stack 22. The second coupling protrusion 16B extends in the longer direction (right-left direction illustrated on the paper) of the battery stack 22. The second coupling protrusion 16B partially extends to a lower side of the battery module 13.

As illustrated in the drawing, the side plate 14 and the bottom plate 16 are coupled to each other via the coupling holes 14C and 16C (refer to FIG. 3) by using the rivets 24. Meanwhile, the side plate 14 and the end plate 15 are coupled to each other via the coupling holes 14C and 15A (refer to FIG. 3) by using the rivets 23.

With this structure, the side plates 14, the end plates 15, and the bottom plate 16 are coupled to one another via the rivets 23 and 24 to constitute a storage and protection frame having a box shape for housing the battery stack 22. In the state in which the battery pack 10 is mounted to the vehicle body of the vehicle 11, the battery stack 22 is prevented from coming into direct contact with the vehicle body and so on due to vibrations of the vehicle 11 or the like. Thus, it is possible to avoid damaging the battery cells 21.

Moreover, as described above, the first and second coupling protrusions 14B and 16B are disposed at four corners of the storage and protection frame along the longer direction (right-left direction illustrated on the paper) of the battery stack 22, and they function as a skeletal frame.

In one example, at the time collision occurs from a rear side of the vehicle 11, a large impact is applied to the rear side of the vehicle 11, and a rear bumper 11B (refer to FIG. 1) protrudes toward inside of the vehicle 11. At this time, the first and second coupling protrusions 14B and 16B receive the impact and prevent the battery cells 21, which constitute the battery stack 22, from being damaged.

That is, although being mounted to the vehicle 11 without using a typical battery case, the battery module 13 is protected by the storage and protection frame, which includes the side plates 14, the end plates 15, and the bottom plate 16. The battery pack 10 does not use a typical battery case, resulting in a reduction in production cost and in a decrease in weight. In addition, brackets for attaching the battery module 13 to a typical battery case are not used accordingly.

The side plate 14 is formed into one body of an extruded material, as described above, and thus, its length in the longer direction is adjustable in accordance with the length of the battery stack 22. Similarly, the bottom plate 16 is also formed into one body of an extruded material, and thus, its length in the longer direction is adjustable in accordance with the length of the battery stack 22. As a result, the shapes of the side plate 14 and the bottom plate 16 are easily changed in accordance with the length of the battery stack 22, or the like. Thus, they can be used in each type of vehicle, unlike a typical battery case, whereby production cost can be reduced.

FIGS. 5A to 5D are perspective views of the battery pack 10 of this embodiment. FIGS. 5A and 5B illustrate a battery pack 10 including two battery modules 13. On the other hand, FIGS. 5C and 5D illustrate a battery pack 10 including four battery modules 13.

In the battery pack 10 illustrated in FIG. 5A, two battery modules 13 are arranged in the longer direction (right-left direction illustrated on the paper) and are fixed in a flat state by using the cover plate 31. The cover plate 31 is formed, for example, by using resin or a steel plate. As described above, the cover plate 31 is coupled to the first coupling protrusions 14B (refer to FIG. 3) of the side plates 14 via the coupling holes 14D and 14E (refer to FIG. 3) by using bolts and nuts. For this reason, the cover plate 31 has coupling holes 31A and 31B that correspond to the coupling holes 14D and 14E (refer to FIG. 3), along the longer direction.

As illustrated in the drawing, the cover plate 31 is longer than the battery stack 22 in the longer direction (right-left direction illustrated on the paper). A vehicle body fixing part 32 to be mounted to the vehicle body of the vehicle 11 is provided at each end of the cover plate 31.

With this structure, the vehicle body fixing parts 32 of the cover plate 31 are fixed to the vehicle body of the vehicle 11 by using bolts and nuts, whereby the battery pack 10 is fixed to the vehicle 11. The cover plate 31 is fixed to the first coupling protrusions 14B functioning as the skeletal frame, as described above. This structure mitigates vibrations during traveling of the vehicle 11, and so on, and prevents the battery cells 21 from hitting each other.

In the battery pack 10 illustrated in FIG. 5B, two battery modules 13 are arranged in the shorter direction (front-rear direction illustrated on the paper) and are fixed in a flat state by using the cover plate 33. As in the case of the cover plate 31, the cover plate 33 has coupling holes 33A and 33B at positions corresponding to the coupling holes 14D and 14E (refer to FIG. 3) of the first coupling protrusions 14B (refer to FIG. 3).

As illustrated in the drawing, the battery pack 10 can be customized by changing the coupling direction of the battery modules 13 in accordance with the housing space 12 (refer to FIG. 1) of the vehicle 11. The battery pack 10 is fixed to the vehicle body of the vehicle 11 via vehicle body fixing parts 34 of the cover plate 33 by using bolts and nuts.

The battery pack 10 illustrated in FIG. 5C includes four battery modules 13 such that battery modules 13 that are stacked and fixed in a two-stage manner are fixed in parallel to each other in the longer direction (right-left direction illustrated on the paper). This structure uses the cover plate 31 illustrated in FIG. 5A, and the cover plate 31 is fixed to the first coupling protrusions 14B (refer to FIG. 3) of the battery modules 13 on the upper stage. The battery pack 10 is fixed to the vehicle body of the vehicle 11 via the vehicle body fixing parts 32 of the cover plate 31 by using bolts and nuts.

The battery pack 10 illustrated in FIG. 5D includes four battery modules 13 such that battery modules 13 that are stacked and fixed in a two-stage manner are fixed in parallel to each other in the shorter direction (front-rear direction illustrated on the paper). This structure uses the cover plate 33 illustrated in FIG. 5B, and the cover plate 33 is fixed to the first coupling protrusions 14B (refer to FIG. 3) of the battery modules 13 on the upper stage. The battery pack 10 is fixed to the vehicle body of the vehicle 11 via vehicle body fixing parts 34 of the cover plate 33 by using bolts and nuts.

FIG. 6A is a perspective view of the cooling mechanism 41 of the battery pack 10 of this embodiment. FIG. 6B is a sectional view of the cooling mechanism 41 of the battery pack 10 of this embodiment. FIG. 6C is a sectional view of an assembled structure of the cooling mechanism 41 of the battery pack 10 of this embodiment. Note that FIG. 6A illustrates a state of disengaging the end plates 15 from the side plates 14 for convenience of explanation.

As illustrated in FIG. 6A, the battery module 13 of the battery pack 10 is provided with the cooling mechanism 41 for cooling the battery cells 21 thereinside. The cooling mechanism 41 mainly has the air inlet 42, the air outlet 43, cooling air paths 44 and 45, the cooling gaps 46 (refer to FIG. 6B), and a cooling duct (not illustrated). The air inlet 42 is provided in the end plate 15 on the front end side (left side illustrated on the paper). The air outlet 43 is provided in the end plate 15 on the rear end side (right side illustrated on the paper). The cooling air path 44 communicates with the air inlet 42. The cooling air path 45 communicates with the air outlet 43. The cooling gaps 46 make the cooling air paths 44 and 45 communicate with each other. The cooling duct communicates with the air inlet 42. In one example, the cooling air path 44 may correspond to a “first cooling air path”, and the cooling air path 45 may correspond to a “second cooling air path”.

As illustrated in the drawing, the air inlet 42 is provided in the end plate 15 on the upstream of the cooling mechanism 41. Although not illustrated in the drawing, a cooling duct that communicates with an air conditioner (not illustrated) of the vehicle 11 is coupled to the air inlet 42 of the end plate 15. In these conditions, cooling air that is generated by the air conditioner is sent into the battery module 13 via the air inlet 42.

As illustrated in FIG. 6B, the side plate 14 is arranged separately from the side of the battery stack 22 to form the cooling air path 44 or 45 between the side plate 14 and the battery stack 22 inside the battery module 13. As described above, the battery cells 21 that constitute the battery stack 22 are arranged with the cooling gaps 46 in the longer direction (right-left direction illustrated on the paper) of the battery stack 22.

Herein, as illustrated in FIG. 6C, in the side plates 14, the upper parts of the plate-shaped bodies 14A and the first coupling protrusions 14B press to fix upper end corners of the separators 25 (refer to FIG. 3). Meanwhile, in the bottom plate 16, the second coupling protrusions 16B determine the positions of lower end corners of the separators 25. With this structure, the separators 25 are fixed while being pressed to the bottom plate 16 by the side plates 14. In these conditions, when vibrations are generated during traveling of the vehicle 11, and even when impact occurs due to vehicle collision, deviation of the separators 25 is suppressed, and the battery cells 21 are prevented from being damaged due to the battery stack 22 hitting surrounding components and so on.

The structure of fixing the separators 25 by the side plate 14 is utilized to form the cooling air path 44 or 45 between the side plate 14 and the battery stack 22.

With this structure, as indicated by the arrows 47, cooling air that enters the cooling air path 44 from the air inlet 42 via the cooling duct flows to the end plate 15 on the other side while passing through the cooling gaps 46 to the cooling air path 45. Thereafter, the cooling air that flows in the cooling air path 45 is discharged from the air outlet 43 of the end plate 15 to the outside of the battery module 13.

The cooling air cools the battery cells 21 from the sides while flowing through the cooling air paths 44 and 45. In particular, it cools the battery cells 21 from the front surfaces and the rear surfaces during passing through the cooling gaps 46. In this manner, the cooling air prevents the battery cells 21 from overheating.

As described by using FIGS. 5A to 5D, in mounting the battery pack 10 to the vehicle body, the upper surface of the battery stack 22 is covered with the cover plate 31 or 33 (refer to FIG. 5A or 5B). Thus, the cooling air hardly leaks from the cooling gaps 46 to the outside of the battery module 13.

The battery module of the embodiment of the disclosure includes the battery stack, the side plates covering the periphery of the battery stack, the bottom plate, and the end plates. This structure prevents the battery stack from being damaged due to vibrations of a vehicle and so on, in the battery module.

The battery pack of the embodiment of the disclosure includes at least one battery module. The battery pack includes the cover plate that covers the upper surface of the battery module. This structure enables changing the layout of a plurality of the battery modules in accordance with the housing space of a vehicle or the like, at which the battery pack is to be placed. The battery pack does not use a typical battery case, resulting in a reduction in production cost and in a decrease in total weight.

1. A battery module comprising:
a battery stack comprising battery cells that are arranged in a first direction;
a bottom plate covering a bottom surface of the battery stack;
end plates respectively covering first ends of the battery stack, the first ends being disposed in the first direction; and
side plates respectively covering second ends of the battery stack, the second ends being disposed in a second direction orthogonal to the first direction, wherein
each of the side plates comprises a first coupling protrusion protruding upward of the battery stack,
the bottom plate comprises a second coupling protrusion protruding downward of the battery stack.

2. The battery module according to claim 1, wherein each of the side plates and the bottom plate are formed of an extruded material.

3. The battery module according to claim 1, wherein
the side plates are fixed to the bottom plate such that a first one of the side plates forms a first cooling air path between the first one of the side plates and the battery stack and a second one of the side plates forms a second cooling air path between the second one of the side plates and the battery stack,
the first cooling air path and the second cooling air path extend in the first direction,
the end plates comprise an air inlet and an air outlet, respectively,
the air inlet communicates with the first cooling air path,
the air outlet communicates with the second cooling air path,
a cooling gap is provided between ones of the battery cells adjacent in the first direction, and
the cooling gap communicates with the first cooling air path and the second cooling air path.

4. The battery module according to claim 2, wherein
the side plates are fixed to the bottom plate such that a first one of the side plates forms a first cooling air path between the first one of the side plates and the battery stack and a second one of the side plates forms a second cooling air path between the second one of the side plates and the battery stack,
the first cooling air path and the second cooling air path extend in the first direction,
the end plates comprise an air inlet and an air outlet, respectively,
the air inlet communicates with the first cooling air path,
the air outlet communicates with the second cooling air path,
a cooling gap is provided between ones of the battery cells adjacent in the first direction, and
the cooling gap communicates with the first cooling air path and the second cooling air path.

5. A battery pack comprising
battery modules each of which is the battery module according to claim 1 and comprising the battery stack, the first coupling protrusion and the second protrusion, the battery modules comprising: battery stacks each of which is the battery stack; first protrusions each of which is the first protrusion; and second protrusions each of which is the second protrusion, and
a cover plate covering upper surfaces of the battery stacks, the cover plate being fixed to the first coupling protrusions, wherein
the battery modules are configured such that
(i) the battery modules are fixed in a stacked manner by coupling the first coupling protrusions and the second coupling protrusions in a height direction of the battery stacks, and
(ii) the battery modules are fixed in parallel to each other by coupling the cover plate and the first coupling protrusions.

6. A battery pack comprising:
battery modules each of which is the battery module according to claim 2 and comprising the battery stack, the first coupling protrusion and the second protrusion, the battery modules comprising: battery stacks each of which is the battery stack; first protrusions each of which is the first protrusion; and second protrusions each of which is the second protrusion, and
a cover plate covering upper surfaces of the battery stacks, the cover plate being fixed to the first coupling protrusions, wherein
the battery modules are configured such that
(i) the battery modules are fixed in a stacked manner by coupling the first coupling protrusions and the second coupling protrusions in a height direction of the battery stacks, and
(ii) the battery modules are fixed in parallel to each other by coupling the cover plate and the first coupling protrusions.

7. A battery pack comprising:
battery modules each of which is the battery module according to claim 3 and comprising the battery stack, the first coupling protrusion and the second protrusion, the battery modules comprising: battery stacks each of which is the battery stack; first protrusions each of which is the first protrusion; and second protrusions each of which is the second protrusion, and
a cover plate covering upper surfaces of the battery stacks, the cover plate being fixed to the first coupling protrusions, wherein
the battery modules are configured such that
(i) the battery modules are fixed in a stacked manner by coupling the first coupling protrusions and the second coupling protrusions in a height direction of the battery stacks, and
(ii) the battery modules are fixed in parallel to each other by coupling the cover plate and the first coupling protrusions.

8. A battery pack comprising:
battery modules each of which is the battery module according to claim 4 and comprising the battery stack, the first coupling protrusion and the second protrusion, the battery modules comprising: battery stacks each of which is the battery stack; first protrusions each of which is the first protrusion; and second protrusions each of which is the second protrusion, and
a cover plate covering upper surfaces of the battery stacks, the cover plate being fixed to the first coupling protrusions, wherein
the battery modules are configured such that
(i) the battery modules are fixed in a stacked manner by coupling the first coupling protrusions and the second coupling protrusions in a height direction of the battery stacks, and
(ii) the battery modules are fixed in parallel to each other by coupling the cover plate and the first coupling protrusions.

9. The battery pack according to claim 5, wherein
the cover plate comprises a battery stack part covering the battery stacks and a vehicle body fixing part that extends outward from the battery stack part, and
the vehicle body fixing part is configured to be fixed to a vehicle body of a vehicle.

10. The battery pack according to claim 6, wherein
the cover plate comprises a battery stack part covering the battery stacks and a vehicle body fixing part
that extends outward from the battery stack part, and the vehicle body fixing part is configured to be fixed to a vehicle body of a vehicle.

11. The battery pack according to claim 7, wherein
the cover plate comprises a battery stack part covering the battery stacks and a vehicle body fixing part that extends outward from the battery stack part, and
the vehicle body fixing part is configured to be fixed to a vehicle body of a vehicle.

12. The battery pack according to claim 8, wherein
the cover plate comprises a battery stack part covering the battery stacks and a vehicle body fixing part that extends outward from the battery stack part, and
the vehicle body fixing part is configured to be fixed to a vehicle body of a vehicle.
